(19) United States
(12) Patent Application Publication
(10) Pub. No.: US 2025/0015871 A1
(43) Pub. Date: Jan. 9, 2025

(54) SYSTEMS AND METHODS RELATED TO SPATIAL MODULATION FOR WIRELESS LOCAL AREA NETWORK

(71) Applicant: HUAWEI TECHNOLOGIES CO., LTD., SHENZHEN (CN)

(72) Inventors: Jung Hoon SUH, Kanata (CA); Yan XIN, Kanata (CA); Osama ABOUL-MAGD, Kanata (CA); Kwok Shum AU, Kanata (CA)

(73) Assignee: HUAWEI TECHNOLOGIES CO., LTD., SHENZHEN (CN)

(21) Appl. No.: 18/583,004

(22) Filed: Feb. 21, 2024

Related U.S. Application Data
(60) Provisional application No. 63/524,890, filed on Jul. 4, 2023.

(51) Int. Cl. H04B 7/06; H04W 84/12

(52) U.S. Cl. CPC H04B 7/0697; H04W 84/12

(57) ABSTRACT

Methods, systems and apparatus related to spatial modulation for WLAN (IEEE 802.11) are provided. A plurality of spatial antenna streams of modulation symbols are generated based on a dynamic mapping of a plurality of spatial streams to the plurality of spatial antenna streams. The dynamic mapping may be based on a stream of non-channel-encoded information bits, in accordance with a spatial modulation. The method may further include causing driving of a plurality of antennas based on the plurality of spatial antenna streams to transmit an IEEE 802.11 frame. The plurality of antennas may be greater in number than or equal in number to the plurality of spatial antenna streams. An IEEE 802.11 frame can include an indication that the frame was transmitted using spatial modulation. The indication may be in a subfield within a SIG field of a PHY header of the IEEE 802.11 frame.

### CROSS-REFERENCE TO RELATED APPLICATIONS

This application claims priority to U.S. Provisional Patent Application No. 63/524,890, filed Jul. 4, 2023, the contents of which are incorporated herein by reference.

### FIELD OF THE INVENTION

The present invention pertains to wireless communication or networking, and in particular to methods, systems and apparatus related to spatial modulation for wireless local area network (WLAN).

### BACKGROUND

A common use case for Wi-Fi™ (IEEE 802.11) communication systems is a single client associated with a basic service set (BSS). An access point (AP) may typically have more transmitter (TX) antennas than the client device. The client device is limited by the number of receiver (RX) antennas, and as a result, the throughput of a single user multiple input multiple output (SU-MIMO) between a single AP and a single station (STA) is limited by the number of RX antennas. While spatial modulation (SM) is discussed in the context of WLAN and Wi-Fi™ systems, existing solutions provide little detail on how SM may be leveraged to deal with throughput limitation caused by limited RX antennas.

Therefore, there is a need for methods, systems and apparatus for spatial modulation for WLAN that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure may provide for methods, systems and apparatus related to spatial modulation for WLAN. According to an aspect a method, by a device of an IEEE 802.11 transmitter, may be provided. The method may include generating a plurality of spatial antenna streams of modulation symbols based on a dynamic mapping of a plurality of spatial streams (e.g. of modulation symbols) to the plurality of spatial antenna streams. The dynamic mapping may be based on a stream of information bits, in accordance with a spatial modulation. The method may further include causing driving of a plurality of antennas based on the plurality of spatial antenna streams to transmit an IEEE 802.11 frame. The plurality of antennas may be greater in number than or equal in number to the plurality of spatial antenna streams.

The plurality of antennas may be greater in number than the plurality of spatial antenna streams. Driving the plurality of antennas based on the plurality of spatial antenna streams may include applying the spatial antenna streams to drive the plurality of antennas in accordance with a linear mapping representable by an Antennas Mapping matrix. The Antennas Mapping matrix may be a (linear algebra) identity matrix, The Antennas Mapping matrix may be a matrix other than an identity matrix. The plurality of spatial antenna streams may be an intermediate stage which are subsequently mapped to and used to drive the plurality of antennas.

The method may further include applying a respective cyclic shift delay to each of a subset of the plurality of spatial streams prior to the dynamic mapping of the plurality of spatial streams. The method may further include applying a respective cyclic shift delay to each of a subset of the plurality of spatial antenna streams provided as outputs of the dynamic mapping. The stream of information bits may be a non-channel-encoded bit stream.

According to another aspect, another method, by a device of an IEEE 802.11 transmitter, may be provided. The method includes causing transmission of an IEEE 802.11 frame using spatial modulation. The IEEE 802.11 frame may include an indication that the IEEE 802.11 frame is transmitted using the spatial modulation, the indication being a subfield within a SIG field of a PHY header of the IEEE 802.11 frame.

The SIG field may be a U-SIG field or a UHR-SIG field. The subfield may have a length of one bit. Transmitting the IEEE 802.11 frame using spatial modulation may include generating a number of spatial antenna streams, of the spatial modulation, which are used to drive a plurality of antennas greater in number or equal in number to the number of spatial antenna streams, the number of spatial antenna streams being indicated in a U-SIG field or a UHR-SIG field of the IEEE 802.11 frame.

According to another aspect, another method, by a device of an IEEE 802.11 transmitter, may be provided. The method includes parsing a non-channel-encoded bit stream into a first stream and a second stream. The method may further include generating a plurality of spatial streams of modulation symbols based on the second stream. The method may further include dynamically mapping the plurality of spatial streams of modulation symbols to a plurality of spatial antenna streams based on the first stream, without channel encoding the first stream, thereby providing for spatial modulation of the bit stream. The method may further include causing driving of a plurality of antennas based on the plurality of spatial antenna streams to transmit an IEEE 802.11 frame, the plurality of antennas being greater in number than or equal in number to the plurality of spatial antenna streams. The non-channel-encoded bit stream may be a scrambled bit stream.

The method may further include channel encoding the second stream to provide an encoded second stream. Generating the plurality of spatial streams of modulation symbols may be based on the encoded second stream.

The method may further include applying a respective cyclic shift delay to each of a subset of the plurality of spatial streams prior to said dynamically mapping of the plurality of spatial streams. The method may further include applying a respective cyclic shift delay to each of a subset of the plurality of spatial antenna streams.

The plurality of antennas may be greater in number than the plurality of spatial antenna streams. Driving the plurality of antennas based on the plurality of spatial antenna streams may include applying the spatial antenna streams to drive the plurality of antennas in accordance with a linear mapping representable by an Antennas Mapping matrix. The Antennas Mapping matrix may be other than an identity matrix. The plurality of spatial antenna streams may be an intermediate stage which are subsequently mapped to and used to drive the plurality of antennas.

According to another aspect, an apparatus may be provided. The apparatus includes modules or electronics configured to perform one or more of the methods and/or implement one or more of the systems described herein.

According to one aspect, an apparatus may be provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium may be provided, where the computer readable medium stores program code executed by a device and the program code is used to perform one or more of the methods and systems described herein.

According to one aspect, a chip may be provided, where the chip includes a processor and a data interface, and the processor reads, by using the data interface, an instruction stored in a memory, to perform one or more of the methods and systems described herein. Aspects may further include the memory.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a table for selection of 2 TX antennas out of 4 available TX antennas using two AS bits, according to an aspect.

FIG. 2 illustrates a table for selection of 2 TX antennas out of 8 available TX antennas using three AS bits, according to an aspect.

FIG. 3 illustrates an ultra high reliability (UHR) physical protocol data unit (PPDU) format, according to an aspect.

FIG. 4 illustrates an SM TX design flow with the CSD applied to the SS, according to an aspect.

FIG. 5 illustrates an SM TX design flow with the CSD applied to the SAS, according to an aspect.

FIG. 6 illustrates an SM RX design flow of an SM frame, according to an aspect.

FIG. 7 illustrates Goodput performance of SM and SU-MIMO for a first case, according to an aspect.

FIG. 8 illustrates Goodput performance of SM and SU-MIMO for a second case, according to an aspect.

FIG. 9A illustrates an apparatus, such as an IEEE 802.11 device, that may perform any or all of operations of the above methods and features explicitly or implicitly described herein, according to different aspects of the present disclosure.

FIG. 9B illustrates another apparatus, such as an IEEE 802.11 device, that may perform some or all of operations of the above methods and features explicitly or implicitly described herein, according to aspects of the present disclosure.

FIG. 10 illustrates a method, by a device of an IEEE 802.11 transmitter, according to an aspect.

FIG. 11 illustrates another method, by a device of an IEEE 802.11 transmitter, according to an aspect.

FIG. 12 illustrates another method, by a device of an IEEE 802.11 transmitter, according to an aspect.

It will be noted that throughout the appended drawings, like features are identified by like reference numerals.

### DETAILED DESCRIPTION

Embodiments of the present disclosure provide for apparatus, methods and systems related to spatial modulation for WLAN in general and in particular for IEEE 802.11 (Wi-Fi™) wireless networks. According to spatial modulation, multiple antennas are used to transmit, and information is conveyed by the transmitter selecting which antenna(s) are used to transmit at a given time and by the receiver discerning which antenna(s) were used to transmit at that time.

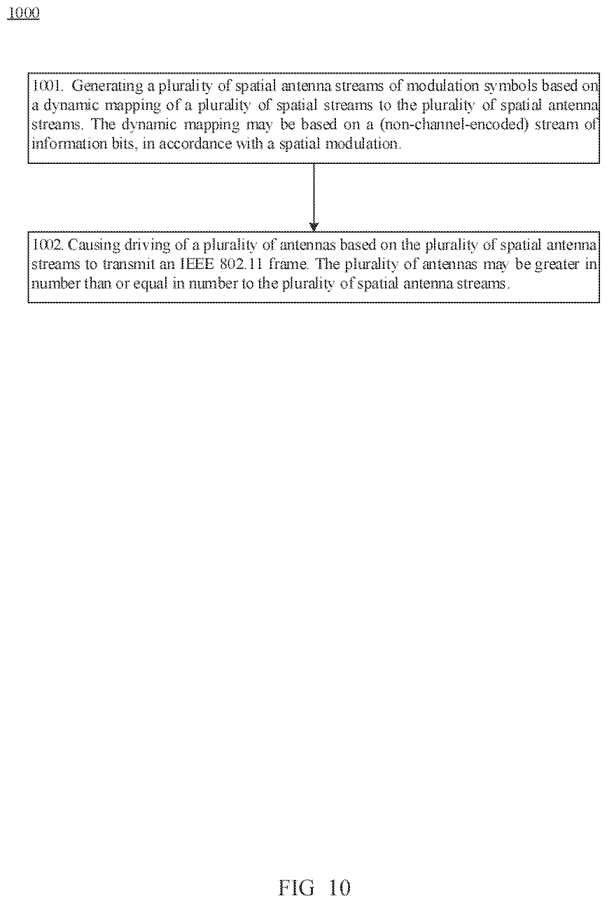

According to an aspect, referring to FIG. 10, a method 1000, by a device of an IEEE 802.11 transmitter, may be provided. The method 1000 includes generating 1001 a plurality of spatial antenna streams (430 or 530) of modulation symbols based on a dynamic mapping of a plurality of spatial streams (432 or 532) to the plurality of spatial antenna streams. The dynamic mapping may be based on a stream (422 or 522) of information bits, in accordance with a spatial modulation. The method 1000 may further include causing 1002 driving of a plurality of antennas based on the plurality of spatial antenna streams to transmit an IEEE 802.11 frame. The plurality of antennas may be greater in number than or equal in number to the plurality of spatial antenna streams. The mapping may be a dynamic mapping in the sense that the mapping varies over time according to the state (e.g. ‘0’ or ‘1’) of certain information carrying bits, such as antenna selection bits. These bits may be referred to as a stream of information bits. Accordingly, a transmitter may perform spatial modulation in a prescribed and effective manner. In particular, in various embodiments, the antenna selection bits are non-channel-encoded bits so that only the original information-carrying bits are used for antenna selection.

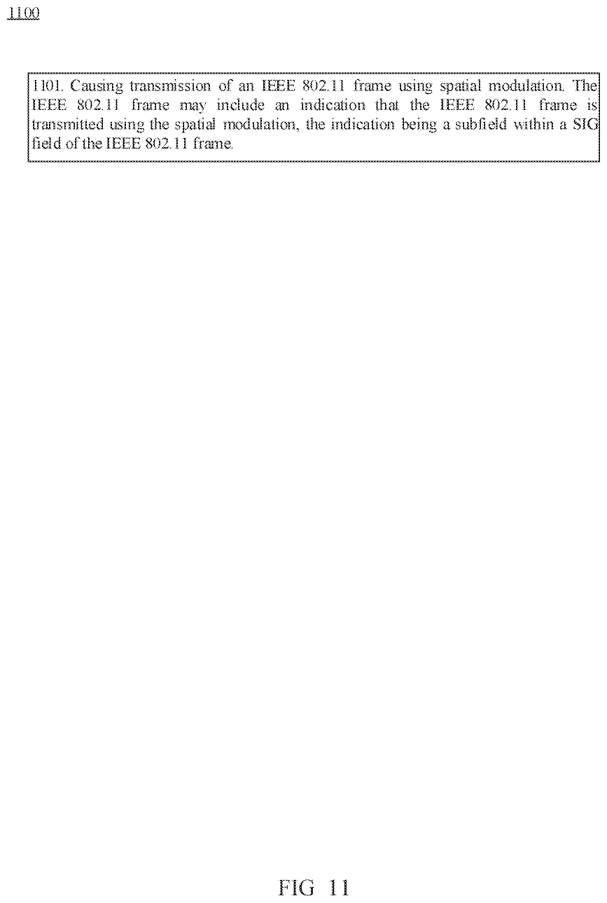

According to another aspect, referring to FIG. 11, method 1100 by a device of an IEEE 802.11 transmitter, may be provided. The method 1100 may include causing 1101 transmission of an IEEE 802.11 frame (e.g., frame 300) using spatial modulation. The IEEE 802.11 frame may include an indication that the IEEE 802.11 frame is transmitted using the spatial modulation, the indication being a subfield within a SIG field of a PHY header of the IEEE 802.11 frame. Accordingly, a transmitter may notify a receiver that a frame is being transmitted using spatial modulation, concurrently with transmission of that frame. The SM indication in the PHY header informs the receiver of the frame type.

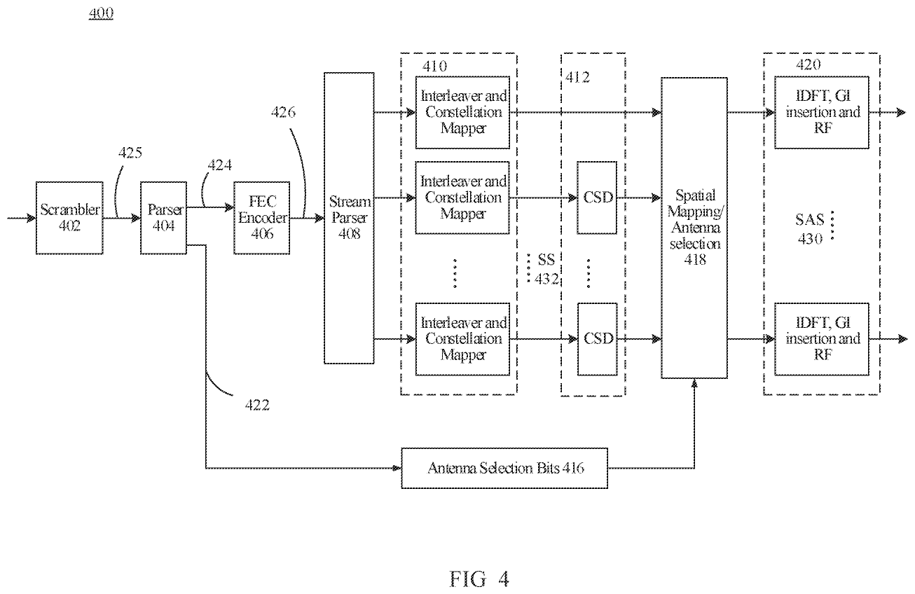

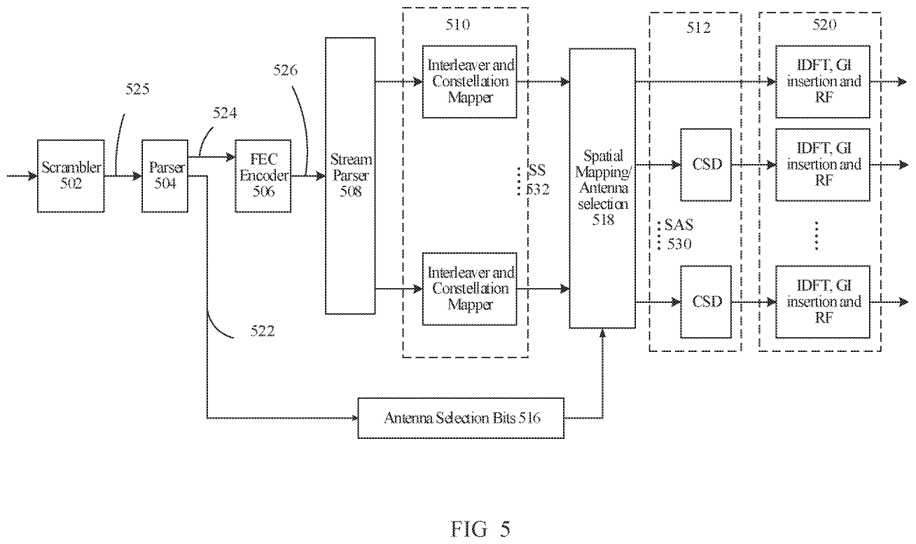

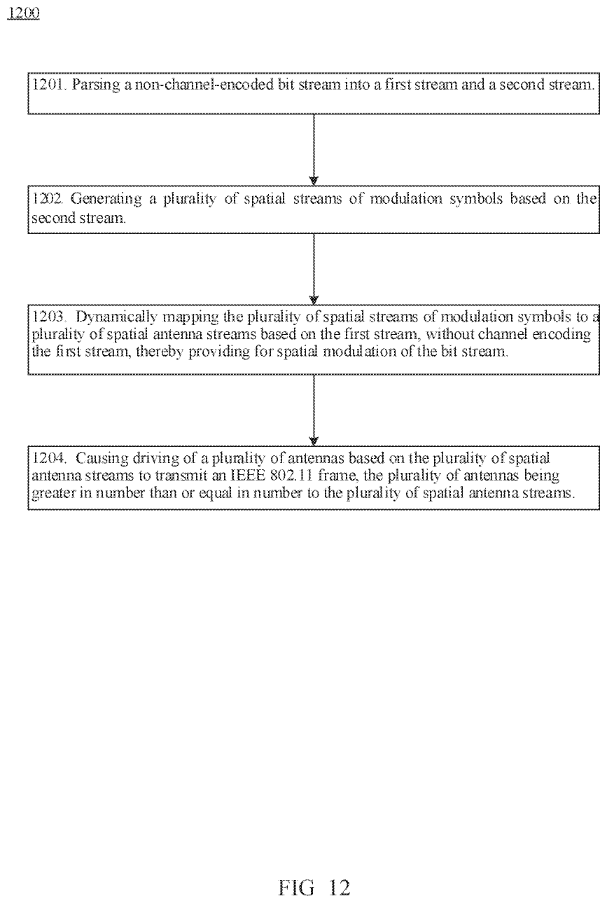

According to another aspect, referring to FIG. 12, method 1200, by a device of an IEEE 802.11 transmitter, may be provided. The method 1200 includes parsing 1201 a non-channel-encoded bit stream (425 in FIGS. 4 and 525 in FIG. 5) into a first stream (422 in FIGS. 4 and 522 in FIG. 5) and a second stream (424 in FIGS. 4 and 524 in FIG. 5). The method 1200 may further include generating 1202 a plurality of spatial streams 432 and 532 of modulation symbols based on the second stream (424 in FIGS. 4 and 524 in FIG. 5). The method 1200 may further include dynamically mapping 1203 the plurality of spatial streams 432 and 532 of modulation symbols to a plurality of spatial antenna streams 430 and 530 respectively based on the first stream 422 and 522 respectively, without channel encoding the first stream, thereby providing for spatial modulation of the bit stream. The method 1200 may further include causing driving of a plurality of antennas based on the plurality of spatial antenna streams to transmit an IEEE 802.11 frame e.g., frame 300, the plurality of antennas being greater in number than or equal in number to the plurality of spatial antenna streams. Accordingly, a transmitter may perform spatial modulation in a prescribed and effective manner. By refraining from channel encoding the first stream, the first stream is used directly for antenna selection. It is noted that the first stream may also be derived from a non-channel-encoded bit stream, and thus in various embodiments channel encoding may be omitted for antenna selection bits at all points subsequent to receiving the bit stream to be transmitted.

A single client associated with a Basic Service Set (BSS) is a common use case for Wi-Fi™ systems. An access point (AP) may typically have up to 8 transmitter (TX) antennas, but the client device is limited by the number of receiver (RX) antennas. It is not common to see more than two RX antennas in a Smart Phone or similar mobile device. The throughput of a single user multiple input multiple output (SU-MIMO) between a single AP and a single station (STA) is limited by the number of RX antennas.

Spatial Modulation (SM) can enhance throughput of wireless communication. Additionally or alternatively, SM can be used to provide adequate throughput for a simplified device setup, which may reduce energy usage, computational complexity, or the like. In SM, information-carrying bits are separated into data bits and antenna selection bits. The antenna selection bits are used to select which antennas among the available set of antennas are used to transmit symbols indicating the data bits. The symbols, as well as the dynamic pattern of which antennas transmit the symbols, are detected at a receiver and thus both the symbols and the dynamic pattern convey information.

In some cases, a number of TX antennas which is greater than the Number of RX antennas may be necessary, which is appropriate for a single AP and a Single STA use case.

According to an aspect, a wireless local area network (WLAN) design flow may be provided that accommodates SM in a Wi-Fi™ system. According to an aspect, a WLAN Physical Layer (PHY) protocol data unit (PPDU) may be provided that indicates an SM frame in a SIG field. Accordingly, an SM frame may be indicated in a SIG field of a WLAN PPDU.

To date, there has been only limited description on the detailed design flow of SM for WLAN. Furthermore, it has been recognized by the inventors that the encoding of AS bits may be unnecessary and may lead to throughput drop. Further, it is desirable to move away from designs in which the throughput may be limited by the number of RX antennas. By refraining from channel encoding (e.g. FEC encoding) the stream that is used as a basis for the spatial modulation (e.g. as antenna selection bits), an encoding/decoding step is avoided, which may improve efficiency and throughput. Furthermore, channel encoding of such a bit stream is unnecessary for achieving an adequately low bit error rate in the disclosed spatial modulation configuration.

According to an aspect, AS bits are not encoded (also referred to as channel encoded) so only the (e.g. raw, non-channel-encoded) information bits are used for antenna selection. Channel encoding may refer to forward error correcting (FEC) encoding, or other types of encoding which introduces redundancy bits. Where FEC encoding is mentioned herein, other types of channel encoding, typically with error correcting capability, can be used in place of FEC encoding. According to an aspect, an SM frame indication may be provided in a signal (SIG) field (PHY Header). According to an aspect, a cyclic shift delay (CSD) may be applied before or after the mapping of the spatial stream (SS) to spatial antennas stream (SAS) in SM. It is noted that scrambling of bits does not introduce redundancy and thus does not fall under the above definition of channel encoding. Thus, information bits (possibly after scrambling) may be fed directly to an antenna selection module which selects transmit antennas for use in a SM operation.

For a single user multiple input multiple output (SU-MIMO) transmission, the rank of the transmission is limited by the number of radio frequency (RF) chains in the RX. That is, the number of available TX RF chains is greater than or equal to the number of RX RF chains. When the number of TX RF chains are greater than the rank of the transmission, the TX RF chains may be randomly selected according to the rank of the transmission among the available total TX RF chains. The random selection of the TX RF chains may be determined by the selection bits (antenna selection bits) which are also a part of the source data. The random selection of the TX RF chains may take place every subcarrier.

In the above context, rank may be regarded as the dimension of the vector space generated (or spanned) by its columns (or rows). That is, when the transmitting signal is described in vector form, rank may indicate the number of independent data elements in that signal vector. This may be the same as the number of spatial Streams.

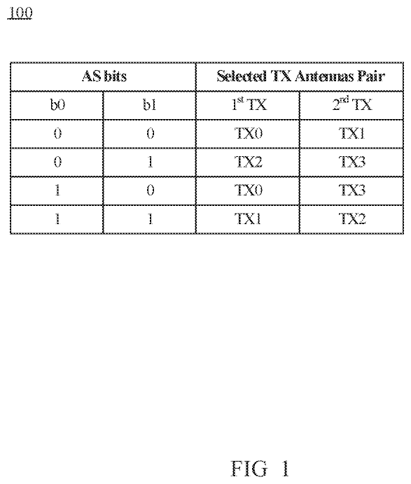

An example is described where 2 TX antennas is selected from 4 available TX antennas. This example assumes that the number of TX antennas to be the number of TX RF chains. This example is based on 4 TX antennas, 2 RX antennas with rank 2 (the number of spatial stream (Nss) 2) transmission. In this case, rather than applying a 4×2 Q-matrix to map 2 Spatial-Streams (SS) to 4 TX antennas, 2 TX antennas may be randomly selected according to the table illustrated in FIG. 1. Random selection may refer to the data being random based on applied source coding to the data information, where the AS bits are data bits. In the example, we assume that the number of TX antenna to be the number of TX RF chain (or TX antenna port). In some aspects, the TX RF chain may be SAS.

FIG. 1 illustrates selection of 2 TX antennas out of 4 available TX antennas using two AS bits, according to an aspect. Referring to the example, since the Nss is 2, two stream of data bits may be denoted as d0 and d1 at each subcarrier, where each of d0 or d1 is a Quadrature Amplitude Modulation (QAM) symbol according to the Modulation and Coding Scheme (MCS) of data.

According to an aspect, if the selected TX antennas are TX0 and TX1, then, do may be transmitted from TX0 and d1 may be transmitted from TX1, while TX2 and TX3 transmit Null data with no energy. If the selected TX antennas are TX0 and TX3, then, the d0 may be transmitted from TX0 and d1 may be transmitted from TX3, while TX1 and TX2 transmit the Null data with no energy. According to an aspect, the Antenna Selection bits are not (channel) encoded or interleaved, so this information (the non-encoded AS bits) effectively corresponds to the MCS 3 of the data information in terms of the total information bits. (The MCS3 carries four coded bits per subcarrier, so the actual number of information bits is 2 (because the code rate is 1/2 for MCS3, that is, two information bits create four coded bits).)

Referring to table 100 in FIG. 1, the selected TX antenna pairs may be based on AS bits, b0 and b1. For example, b0 and b1 values of 0 and 0, respectively, may correspond to or select TX0 and TX1 as the first and second selected TX antennas respectively. Similarly, b0 and b1 values of 0 and 1, respectively, may correspond to or select TX2 and TX3 as the first and second selected TX antennas respectively. Further, b0 and b1 values of 1 and 0, respectively, may correspond to or select TX0 and TX3 as the first and second selected TX antennas respectively. Further, b0 and b1 values of 1 and 1, respectively, may correspond to TX1 and TX2 as the selected first and second selected TX antennas respectively.

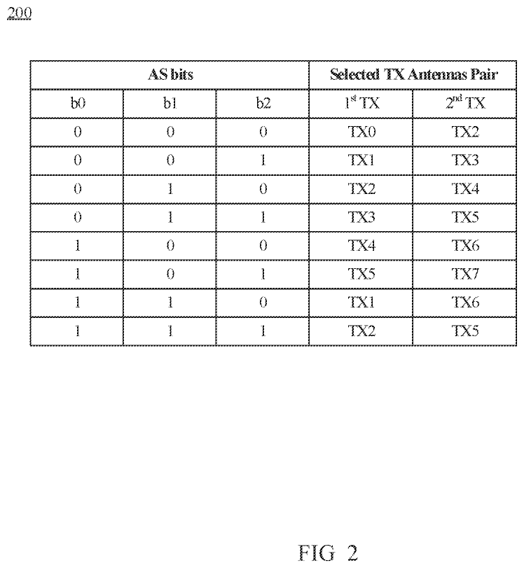

According to an embodiment, SM can be extended to other combination of TX antennas and RX antennas. For example, SM can be extended to the case of 8 TX antennas and 2 RX antennas with 3 Antenna Selection bits, as illustrated in FIG. 2. FIG. 2 illustrates selection of 2 TX antennas out of 8 available TX antennas using three AS bits, according to an aspect. Table 200 may refer to a case of 8 TX antennas (assuming 8 TX RF chains to be the 8 TX antennas) with rank 2 transmission and 2 RX antennas.

Referring to table 200 in FIG. 2, the selected TX antenna pairs may be based on AS bits, b0, b1 and b2. For example, b0, b1 and b2 values of 0, 0, and 0 respectively, may correspond to or select TX0 and TX2 as the first and second selected TX antennas respectively. Similarly, different combination of TX antenna pairs may be selected based on different setting of AS bits, b0, b1 and b2 as illustrated in table 200 in FIG. 2. Accordingly, three AS bits at a time, obtained from an information-carrying bit stream, are used to select a pair of TX antennas according to the table. This selected pair of TX antennas are used to transmit three information-carrying bits.

The mapping of the AS bits to the selected TX antennas pairs, e.g., table 100 or 200, is not limited to the illustrated mapping. The mapping may be dynamic and may be changed to different combinations of AS bits and selected TX antenna pairs. However, it is also considered that the illustrated mappings may exhibit a certain desirable performance level and thus may represent a particularly useful implementation.

According to an aspect, a Wi-Fi™ 8 (i.e. 8th generation Wi-Fi™ e.g. according to the IEEE 802.11bn standards documents) AP or device (future devices) may be configured according to one or more of methods, features, and embodiments described herein. Embodiments may potentially be applicable to standards subsequent to Wi-Fi™ 8.

According to an aspect, the Number of Long Training Field (LTFs) in a frame may depend on the Number of available SAS. That is, the channel which needs to be estimated may be the full channel between the RX and the total available SAS in the TX side.

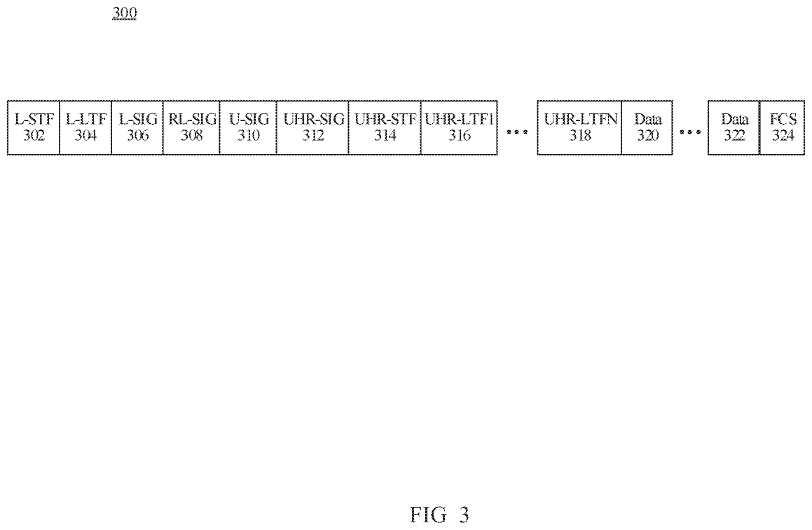

According to an aspect, a SIG field (e.g. in the frame's header) may be used to indicate that a frame is an SM frame. For example, a 1-bit subfield in the SIG field may be used to indicate that the frame is an SM frame (i.e. that the IEEE 802.11 frame is transmitted using the spatial modulation). FIG. 3 illustrates an ultra high reliability (UHR) PPDU format, according to an aspect. The frame 300 (an IEEE 802.11 frame) may be transmitted by an IEEE 802.11 transmitter.

The UHR frame format 300 illustrates an expected UHR frame format. The UHR frame format 300 may differ from the exact, adopted or future frame format as determined according to the UHR Standards progress. The UHR frame format 300 may include one or more fields indicating: a legacy short training field (L-STF) 302, a legacy long training field (L-LTF) 304, a legacy SIG field (L-SIG) 306, a Repeated legacy SIG field (RL-SIG) 308, a universal SIG field (U-SIG) 310, a UHR-SIG 312, a UHR-STF 314, UHR-LTF 316, 318, data 320 and 322, and frame check sequence (FCS) 324.

According to an aspect, the indication that a frame is an SM frame may be carried in a U-SIG 310 or UHR-SIG 312. For example, a subfield of at least 1 bit in either U-SIG 310 or UHR-SIG 312 may be used to indicate that the frame is an SM frame.

According to an aspect, the number of LTFs may follow the number of available SAS. LTF is the reference signal for channel estimation. The RX side may need to obtain the channel parameters for the entire channel. As an example, the number of SAS may be 4, and the number of RX antennas may be 2. Thus, the size of the actual channel matrix is then 2×4 (need 8 element channel parameters per subcarrier). Thus, the number of LTF should be aligned with the number of available SAS. Assuming that the number of SAS is the same as TX antennas, for the case of 4 TX antennas and 2 RX antennas, SAS is 4, and thus the number of LTFs should be at least 4 LTFs in order to measure the channel between 2 RX and 4 SAS. Thus, the number of LTFs may be equal to or greater than the number of SAS. In some embodiments, the number of LTFs may be indicated in the UHR-SIG field 312.

According to an aspect, a Spatial-Antenna Stream (SAS) may be introduced to the WLAN to embody the SM. On the TX side, Spatial Streams (SS) may be mapped to the Spatial-Antenna Streams (SAS) which may further be mapped to the TX antennas. The Spatial Stream (SS) may be aligned with the rank of the transmission. The SS may be less than or equal to the number of RX antennas. According to an aspect, the Spatial Streams may be mapped to the Spatial-Antenna Streams (SAS) through the Spatial Modulation as described herein, for example, in reference to selection of an appropriate number of TX antennas selected from among the total available TX antennas using AS bits (as shown in table 100 and 200 in FIGS. 1 and 2 respectively and described herein).

According to an aspect, the SAS can be mapped to the TX antennas with the Antennas Mapping matrix, and the number of TX antennas may be greater than or equal to the number of SAS. In some aspects, an identity matrix may be used for mapping the SAS to the TX antennas when the number of TX antennas is equal to the number of SAS. In some aspects, the SAS may be regarded as the Number of TX RF Chains. Although matrices, tables, etc. are used herein for purposes of description, stream mappings, stream-to-antenna mappings, antenna selection operations, etc. can be implemented using appropriate hardware, such as wirings, logic gates or other digital and/or analog circuitry, as will be readily understood by a worker skilled in the art. In some embodiments, in particular, the number of TX antennas is greater than the number of SAS. In this case, the Antennas Selection bits are being used for the selection of the SAS.

The Antennas Mapping matrix may be a matrix including zero values and non-zero (e.g. ‘1’) values. If, for example, the entry at the ith row and jth column of the matrix contains a non-zero value, then the ith spatial stream is mapped to the jth antenna. Other similar representations are also possible.

According to an aspect, the CSD can be applied after the Antennas Selection is done but before taking the Inverse Discrete Fourier Transform (IDFT). According to an aspect, the CSD can be either applied to the SAS or SS. In either case, CSD may be applied before the IDFT, that is, the CSD is done in Frequency Domain in either case. For example, in FIG. 4, CSD 412 is performed prior to operations 420 including IDFT. In this case, CSD is applied to spatial streams 432. As another example, in FIG. 5, CSD 512 is performed prior to operations 520 including IDFT. In this case, CSD is applied to spatial antenna streams 530.

In more detail, FIG. 4 illustrates an SM TX design flow with the CSD applied to the SS, according to an aspect. The SM TX design flow 400 may provide for one or more enhanced operations related to one or more of: parser function block 404, antenna selection bits function block and spatial mapping/antenna selection function block. The TX design flow 400 may comprise one or more function blocks for performing one or more operations related to: scrambler 402, parser 404, forward error correction (FEC) encoder 406, stream parser 408, interleaver and constellation mapper 410, CSD 412, antenna selection bits 416, spatial mapping (or antenna selection) 418, and IDFT, guard interval (GI) insertion and RF 420.

The operations related to interleaver and constellation mapper 410 may apply to each stream generated by the stream parser 408. Referring to FIG. 4, The operations related to IDFT, GI insertion and RF 420 may apply to each SAS 430.

The CSD 412 operations may apply to a subset of SS, e.g., applied to all but the first SS as illustrated. The respective cyclic shift delay may be applied to each of a subset of the plurality of spatial streams prior to the dynamic mapping (referring to spatial mapping 418) of the plurality of spatial streams 432. In FIG. 5, as described herein, the respective cyclic shift delays may be applied to each of a subset of the plurality of spatial antenna streams 530 provided as outputs of the dynamic mapping (performed by the spatial mapping 518).

The parser 404 may parse a non-channel-encoded bit stream 425 into a first stream 422 and a second stream 424. The bit stream 425 may have been previously scrambled by scrambler 402. The plurality of spatial streams 432 of modulation symbols may be generated based on the second stream 424 (after one or more operations performed by one or more of blocks 406, 408 and 410). The dynamic mapping the plurality of spatial streams 432 of modulation symbols to the plurality of spatial antenna streams 430 may be based on the first stream 422. The first stream is a non-channel encoded stream, thereby providing for spatial modulation of the bit stream.

According to an aspect, for SM, another stream 422 (the first stream) may be needed as antenna selection bits for operation of the spatial mapping/antenna selection function block 418. The stream 422 may be generated by the parser 404, after scrambler 402. The stream 422 may be a non-channel-encoded stream as illustrated (e.g. such that no redundancy is introduced into the bit stream to facilitate error detection or correction). Accordingly, data (e.g. source coded data) received at scrambler 402 is scrambled and fed to the parser 404. A portion 424 (second stream) of the output of the parser 404 is fed to the FEC encoder 406, and another portion (first stream 422) is used for AS bits 416. An appropriate number of AS bits may be taken or used, e.g., referring to stream 422, at each subcarrier for selecting TX antennas (e.g., 2 AS bits in reference to table 100 and 3 AS bits in reference to table 200). The parser 404 may separate bits into the first and second streams, such that an appropriate number of bits are diverted into the first stream for use in antenna selection. The FEC encoder 406 outputs an encoded second stream 426 based on the (unencoded) second stream 424.

The encoded second stream 426 is provided to the stream parser 408, which separates (e.g. parses or demultiplexes) the encoded second stream into multiple parts. In the illustrated embodiment, each part is fed to and operated on by a different respective interleaver and constellation mapper 410. Interleaving and constellation mapping can be performed separately or together. Interleaving may involve a re-ordering of bits (or constellation symbols) according to a predetermined rule. Constellation mapping may involve generating modulation symbols based on respective bits. The interleaver(s) and constellation mapper(s) output respective spatial streams 432 of modulation symbols.

The spatial streams 432 are provided to a CSD 412, which applies different respective cyclic shift delays to different respective ones of the spatial streams 432, for example via the use of multiple respective CSD sub-blocks or equivalent functionality. It is noted that one of the spatial streams 432 is not subjected to CSD (or alternatively subjected to a null CSD), corresponding to a CSD of zero. Spatial streams with CSD applied are output by the CSD block 412 and provided to the spatial mapping/antenna selection function block 418.

The spatial mapping 418 operates on the various spatial streams with CSD applied, to dynamically map different ones of these received spatial streams to different outputs, which may be referred to as spatial antenna streams 430. (Spatial antenna streams may refer to a portion of stream following antenna selection.) The number of input spatial streams may be the same as or different from the number of output spatial antenna streams. The spatial mapping is performed based on the values of currently input antenna selection bits 416, for example according to the mapping of FIG. 1 or FIG. 2. The spatial mapping 418 receives a set of antenna selection bits of a stream of such bits, and maps portions of the spatial streams to corresponding spatial antenna streams based on this set of antenna selection bits. This process is then repeated based on a next set of antenna selection bits of the stream, and next portions of the spatial streams, etc. The mapping of spatial streams to spatial antenna streams comprises, at each given instance, defining a correspondence between an input spatial stream and an output spatial antenna stream, and providing a symbol received via this input spatial stream as a symbol of the output spatial antenna stream. Antenna selection may be performed as a per-subcarrier action.

The spatial antenna streams 430 output by the spatial mapping 418 are further operated on by functions 420, which can include IDFT, GI insertion, and RF. The RF portion refers to RF processing, which is performed at the radio frequency, as opposed to baseband. The term radio frequency is not necessarily intended to limit the electromagnetic frequency to a particular band. The output of these functions corresponds to RF signals which are transmitted and which are indicative of a generated signal, frame, or the like. Multiple RF signals, equal to the number of spatial antenna streams, are generated, and each is provided to and transmitted by a different respective transmit antenna. The transmit antennas are at different locations sufficient to facilitate the spatial modulation.

According to an aspect, the SM TX design flow 400 via at least the spatial mapping function block 418 may generate a plurality of spatial antenna streams 430 of modulation symbols based on a dynamic mapping of a plurality of spatial streams 432 to the plurality of spatial antenna streams. The dynamic mapping may be based on a stream 422 of information bits, in accordance with a spatial modulation.

The SM TX design flow 400 may further drive a plurality of antennas based on the plurality of spatial antenna streams 430 to transmit an IEEE 802.11 frame (e.g., frame 300). The plurality of antennas may be greater in number than or equal in number to the plurality of spatial antenna streams 430.

Driving the plurality of antennas based on the plurality of spatial antenna streams 430 may include applying the spatial antenna streams 430 to drive the plurality of antennas in accordance with a linear mapping representable by an Antennas Mapping matrix. The plurality of spatial antenna streams 430 may be an intermediate stage which are subsequently mapped to and used to drive the plurality of antennas. Thus, the SAS 430 does not necessarily match directly to the antennas, but rather may represent an intermediate stage of streams. Each stream can be used to drive one antenna or more than one antenna. As will be readily understood by a worker skilled in the art, driving of antennas based on spatial antenna streams (e.g. streams of modulation symbols) may involve various operations such as signal amplification, modulation, and providing electrical signals which cause antennas to emit corresponding electromagnetic signals. Causing such driving can involve emitting signals (e.g. antenna selection/control signals along with suitable spatial antenna streams/modulation symbols) which are then used to drive the antennas.

SAS may be similar or equivalent to an RF chain or antenna port. Thus, the number of SAS may be aligned with the number of RF chains. In some embodiments, the number of TX RF chains may be assumed to be the same as the TX antennas. In some cases, the number of RF chains is the same as the number of TX antennas, E.g., if the number of RF chains is 4, then the number of TX antennas is 4; or if the number of RF chains is 8, then the number of TX antennas is 8. Similarly in some cases, the number of SAS may be the same as the number of TX antennas.

However, some APs may have different number of RF chains than number of TX antennas, e.g., 4 RF chains and 8 TX antennas. In such cases, the number of SAS is equivalent to the number of RF chains (which is different from number of TX antennas).

In some embodiments, the CSD may be applied before antenna selection (e.g., TX design flow 400 where CSD 412 is applied to the SS). In some embodiments, CSD may be applied after antenna selection, for example, CSD may be applied to the SAS as described in reference to FIG. 5.

FIG. 5 illustrates an SM TX design flow with the CSD applied to the SAS, according to an aspect. The SM TX design flow 500 is comparable to the SM TX design flow 400 of FIG. 4, however the CSD operations 512 in SM TX design flow 500 are applied after antenna selection 518, i.e., applied to the SAS. In contrast, the CSD operations 412 in SM TX design flow 400 are applied before antenna selection 418, i.e., applied to the SS. In SM TX design flow 500, CSD is applied to the SAS.

Similar to the SM TX design flow 400, the SM TX design flow 500 may comprise one or more function blocks for performing one or more operations related to: scrambler 502, parser 504, FEC encoder 506, stream parser 508, interleaver and constellation mapper 510, antenna selection bits 516, spatial mapping (or antenna selection) 518, CSD 512, and IDFT, guard interval (GI) insertion and RF 520. The operations related to interleaver and constellation mapper 510 may apply to each stream generated by the stream parser 508. The CSD 512 operations may apply to a subset of SAS, e.g., applied to all but the first SAS as illustrated. The operations related to IDFT, GI insertion and RF 520 may apply to each SAS.

Data (e.g. source coded data) received at scrambler 502 may be scrambled to provide scrambled data 525. and the scrambled data 525 is fed to the parser 504. The parser 504 separates the scrambled data into two streams. A portion 524 of the output of the parser 504 is fed to the FEC encoder 506, and another portion (stream 522) is used for AS bits 516.

Output 526 of the FEC encoder 506, i.e. a channel-encoded bit stream, is fed to the stream parser 508 which separates the channel-encoded bit stream into multiple separate bit streams. Each of these bit streams is operated on by an interleaver and constellation mapper 510 which performs interleaving and generates symbol streams based on the bit streams. The stream parser 508 and interleaver and constellation mapper 510 are similar to the stream parser 408 and interleaver and constellation mapper 410 of FIG. 4. The interleaver and constellation mapper 510 thereby generates a plurality of spatial streams 532 which are provided to the spatial mapping/antenna selection function block 518, which operates similarly to the spatial mapping/antenna selection function block 418 of FIG. 4, using the antenna selection bits 516 to perform antenna selection. The spatial mapping/antenna selection function block 518 receives a number of spatial streams 532 and antenna selection bits 516, and outputs a (possibly different) number of spatial antenna streams 530.

The generated spatial antenna streams 530 are operated on by a CSD block 512, which operates similarly to the CSD block 412 of FIG. 4. Outputs of the CSD block, which are spatial antenna streams with CSD applied, are then subjected to operations 520 such as IDFT, GI insertion and RF, which are similar to the operations 420 of FIG. 4. The output of these functions corresponds to RF signals which are transmitted and which are indicative of a generated signal, frame, or the like.

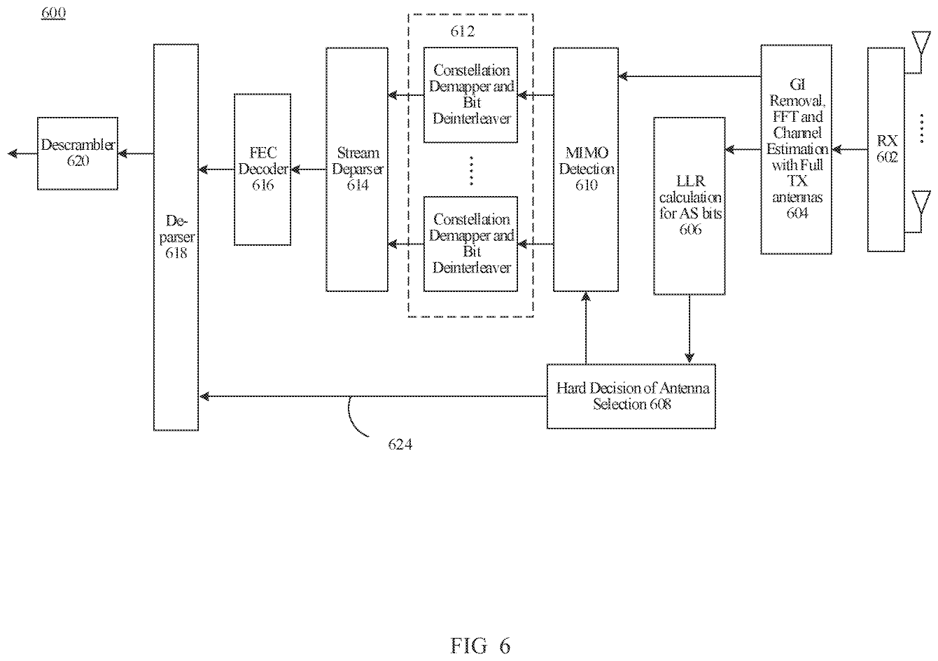

FIG. 6 illustrates an SM receiver (RX) design flow of an SM frame, according to an aspect. The SM RX design flow 600 may comprise one or more function blocks for performing one or more operations related to: RX antennas 602, GI removal, Fast Fourier Transform (FFT) and channel estimation with full TX antennas 604, Log-likelihood ratio (LLR) calculation for AS bits 606, hard decision of antenna selection 608, MIMO detection 610, constellation de-mapper and bit de-interleaver 612, stream de-parser 614, FEC decoder 616, Bit de-parser 619 and descrambler 620.

A plurality of RX antennas 602 receive wireless signals, transmitted for example by the apparatus of FIG. 4 or 5, or a similar apparatus employing SM as described herein. The received wireless signals, possibly after some initial processing (e.g. amplification, etc.) are provided to the function block 604 which performs operations such as removal of guard intervals that were inserted for transmission and FFT on the received signals to counter IFFT performed for transmission. The function block 604 may also perform channel estimation with full TX antennas. For example, MIMO Channel Estimation may be done for the channel between the RX and the TX SAS. That is, for example, if the number of RX is 2 and SAS is 4, then it may be required to estimate the full 2×4 channel, not just the 2×2 channel.

The outputs of the block 604 may be used for LLR calculation for AS bits 606. Thereafter, outputs of the LLR calculation for AS bits may be used to perform hard decision of antenna selection 608. The outputs of the hard decision of antenna selection 608 may be used for MIMO detection 610 of the received data streams in the block 604. MIMO detection block 610 may perform signal separation and detection to recover the individual transmitted streams via estimating the channel conditions and utilizing detection techniques. For this purpose, MIMO detection block 610 further receives output (indicative of received signals) from the function block 604. Further, for each detected stream, one or more operations related to constellation demapper (converting the received symbols back into bit representations) and bit deinterleaver 612 (reversing the interleaving process performed at the TX, restoring the order of the received bits) may be performed. The outputs are then fed into stream deparser 614, which reassembles or reconstructs the restored bits into a continuous stream of data. The stream of data may then be fed into the FEC decoder 616 for detecting and correcting errors that may have occurred during transmission. One or more outputs of the FEC decoder 616 and the hard decision of antenna selection 608 (e.g., stream 624) may be fed to deparser 618 for reversing the operation of a parser and separate the bit stream into its constituent components for further processing or utilization. The output of the deparser 618 may then be fed into the descrambler 620 which removes the scrambling that was applied during transmission (thereby reverting the data to its original data sequence). Output of the descrambler 620 may then be fed back to an upper layer or other recipient of the received bit stream. Output of 604 may be channel parameters and the received signals. Outputs of 606 may be the LLR Antennas Selection (AS) bits which may be real numbers that can be used for the hard decision of AS.

More generally, as is evidenced by FIG. 6, a received signal is processed to determine (estimate) the antennas at the transmitter that generated each portion (e.g. symbol) of the received signal. This processing is performed using function blocks 606 and 608. The information obtained from such processing is used for two purposes. First, it is used to facilitate MIMO detection 610, in order to determine (estimate) the transmitted symbols themselves. These symbols are then used to determine (estimate) the original (second) bit stream (424, 524) used by the transmitter. This estimate is ultimately output by the FEC decoder 616 to the deparser 618. Second, the information (determined antennas at the transmitter) is interpreted as the information-carrying antenna selection bits (416, 516) which were generated by the transmitter based on the first bit stream 422, 522, which in turn was part of a non-channel-encoded bit stream 425, 525. Thus, these determined bits (in stream 624) are also fed to the deparser 618. The deparser 618 then combines these two received streams of bits into a final bit stream, according to a deparsing pattern that is the inverse of the parsing pattern performed by parser 404, 504, to recover (an estimate of) the original non-channel-encoded bit stream 425, 525. Descrambling 620 then completes the recovery process.

The LLR calculation operations at function block 606 may be performed to determine the AS bits (via hard decision of antenna selection 608) for the antenna selection. The RX may have access to the same AS bit mapping to selected TX antennas (e.g., table 100 or 200) to determine the selected TX antennas. As illustrated, the hard decision of antenna selection function block 608 generates a stream 624 in addition to the data stream(s) detected by the MIMO detection 610. The stream 624, which comprises data, is also fed to the deparser 618.

The Log-likelihood ratio (LLR) Calculation for AS bits, referring to block 606, may be processed according to the following ML detection equation to figure out the AS bits:

$$L ( {s}^{i} \vert y , {H}_{\tilde{s}} ) \approx - {min}_{\tilde{s} ∈ {s}_{1}^{i} , \tilde{x} ∈ ℵ} \{ \frac{1}{2 {σ}^{2}} {‖ y - {H}_{\tilde{s}} \tilde{x} ‖}^{2} \} + {min}_{\tilde{s} ∈ {s}_{0}^{i} , \tilde{x} ∈ ℵ} \{ \frac{1}{2 {σ}^{2}} {‖ y - {H}_{\tilde{s}} \tilde{x} ‖}^{2} \} \qquad ( 1 )$$

Here, L(sⁱ|y, H_{\tilde{s}}) is the LLR for the i^{th} Antenna bit selection when the received signal is a vector y across the RX streams and H_{\tilde{s}} is the channel matrix for the selected antenna set. The \tilde{s} is the Selected Antennas bit selection. The s₁ⁱ is the antenna configuration set when the i^{th} Antenna bit selection is 1. The \tilde{x} is the QAM constellation set. The [symbol] is the Entire QAM constellation set.

Taking table 100 in FIG. 1 as an example, for the first AS bit “1” case, the Selected TX Antennas pair would be either (TX0, TX3) or (TX1, TX2). The Selected TX Antennas pair for the first AS bit “0” case would be either (TX0, TX1) or (TX2, TX3). Then, the Euclidean distance may be computed between the received signal and all the possible QAM symbols multiplied with the estimated channels for the corresponding TX Antennas pair, and the minimum Euclidean distance may be chosen. The minimum Euclidean distance for AS bit “0” minus the minimum Euclidean distance for AS bit “1” is the LLR for the corresponding AS bit position.

Once the LLR for each AS bit position is obtained, a hard decision of antenna selection 608 may be performed. An LLR less than “0” may indicate the bit “0” for the corresponding AS bit position. Thus, if LLR is positive, then hard decision output is 1, if LLR is negative, then hard decision output is 0.

Once the AS bits are detected, the remaining MIMO detection may be a routine detection as each vendor has implemented. For example, if a vendor implemented a MIMO detection algorithm with a minimum mean square error (MMSE) detection, then, the same MIMO detection may be used.

In various embodiments, the receiver can be configured to operate as described above with respect to FIG. 6 when the receiver determines that a received frame was transmitted using spatial modulation of a certain type. Such a determination can be made for example by receiving and interpreting an indication within a subfield of a SIG field of a PHY header of the frame. Such an indication has been described previously above with respect to the transmitter.

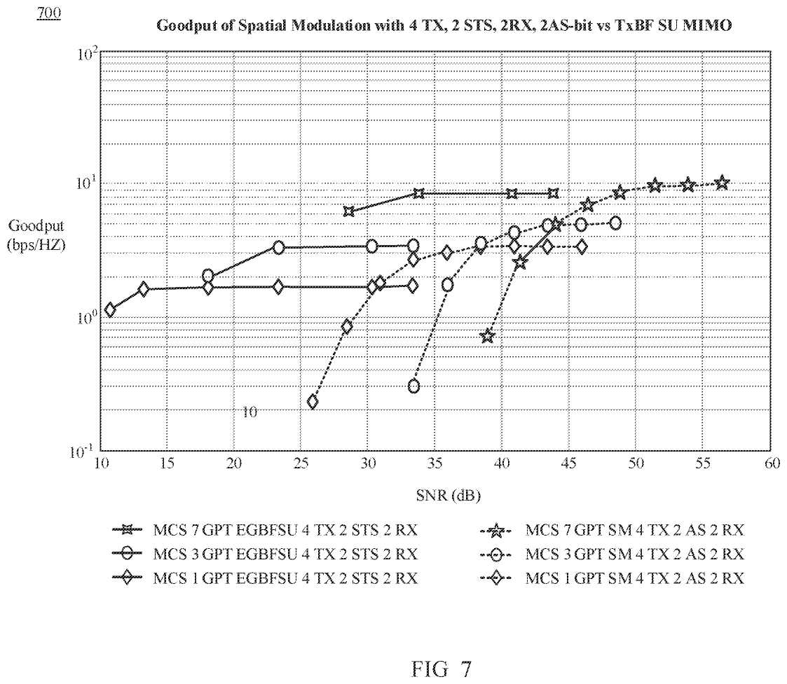

An example of performance of SM, according to an aspect, was evaluated against SU-MIMO in two cases. In the first case, SM performance based on 4TX antennas, 2 SS, and 2 RX antennas was compared to performance of SU-MIMO with eigen beamforming (EGBF) based TxBF (2×2 and transmitted through the 4TX antenna with EGBF applied). In this case, the number of SAS is assumed to be the same as that of TX antenna. The rank of transmission, N_c, is 2; the number of AS bits, N_A is 2; and 2 streams of the of 4 SAS were selected. The results of goodput performance for SM and SU MIMO are illustrated in FIG. 7.

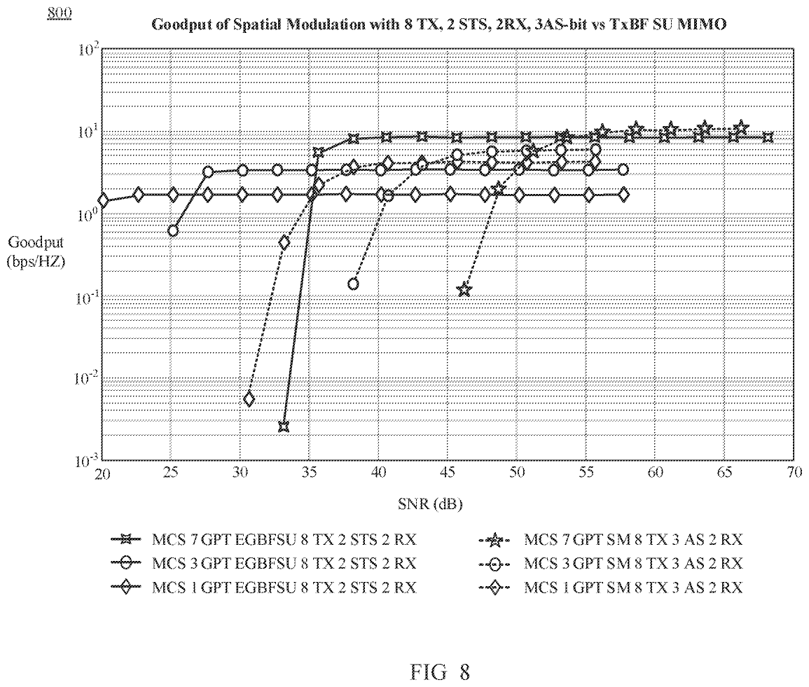

In the second case, SM performance based on 8TX antennas, 2 SS, and 2 RX antennas was compared to performance of SU-MIMO with eigen beamforming (EGBF) based TxBF. In this case, the number of SAS is assumed to be the same as that of TX antenna. The rank of transmission, N_c, is 2; the number of AS bits, N_A is 3; and 2 streams of the of 8 SAS were selected (NSS is 2 because number of TX is 2). The results of goodput performance for SM and SU MIMO are illustrated in FIG. 8.

Both case 1 and case 2 were tested on IEE Channel D, and the Goodput performance was measured in bit per second per hertz (bps/HZ). The Goodput performance is measured as follows:

$$Goodput ( bps / HZ ) = ( 1 - P E R ) ( N\_BPSC * Coderate * N\_c + N\_A ) * {N}_{- s c} / OFDM Symbol Length ( / wo GI ) / BW \qquad ( 2 )$$

where, PER is the packet error rate; BW is bandwidth, N_BPSC is Number of Bits Per Subcarrier; N_c is Rank of the Transmission; N_A is Number of Antenna Selection Bits; and N_{sc} is the total number of data subcarriers. It should be noted that Equation (2) does not consider sounding overhead in the calculation of Goodput for TxBF based SU-MIMO. As may be appreciated, in SU MIMO case, sounding is required to provide CSI feedback, however this overhead is not considered in Equation (2) or in corresponding FIGS. 7 and 8.

FIG. 7 illustrates Goodput performance of SM and SU-MIMO for a first case, according to an aspect. As mentioned, the Goodput performance graph 700 is based on the first case, i.e., 4TX-2SS-2RX SM vs SU-MIMO (with EGBF based TxBF). FIG. 8 illustrates Goodput performance of SM and SU-MIMO for a second case, according to an aspect. Goodput performance graph 800 is based on the second case, i.e., 8TX-2SS-2RX SM vs SU-MIMO (with EGBF based TxBF).

Referring to FIGS. 7 and 8, the SM performance is indicated via solid line and the SU-MIMO performance is indicated via dashed lines. For each case, MCS 1, 3 and 7 are tested separately. As noted, the SU MIMO Goodput performance does not consider the sounding overhead. If sounding overhead is considered, then the SU MIMO performance and SM performance would be comparable at lower SNR values. Even though sounding overhead is not considered in SU MIMO performance, SM performs better than SU MIMO in terms of saturation throughput (because more data is transmitted through AS bits). Further, it should be noted that the Goodput performance is measured bps per HZ, which indicates that the data rate achievable with a given bandwidth may be substantial considering the gain per HZ.

According to an aspect, SAS is introduced so the SS can be mapped to the SAS through the Spatial Modulation manner, that is, through the Antenna Selection. The CSD can be applied before (as in FIG. 4) or after (as in FIG. 5) the SS to SAS mapping in SM (i.e., antenna selection). According to an aspect, SM frame may be indicated in a SIG field (e.g., U-SIG 310 or UHR-SIG 312) in PHY header. As described in reference to SM TX design flow 400 and 500, AS bits may not be encoded, so only the information bits (e.g., stream 422 and 522) can be used for the Antenna Selection.

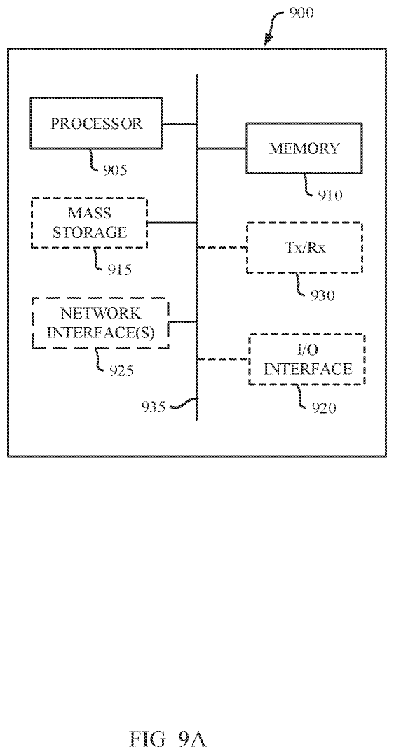

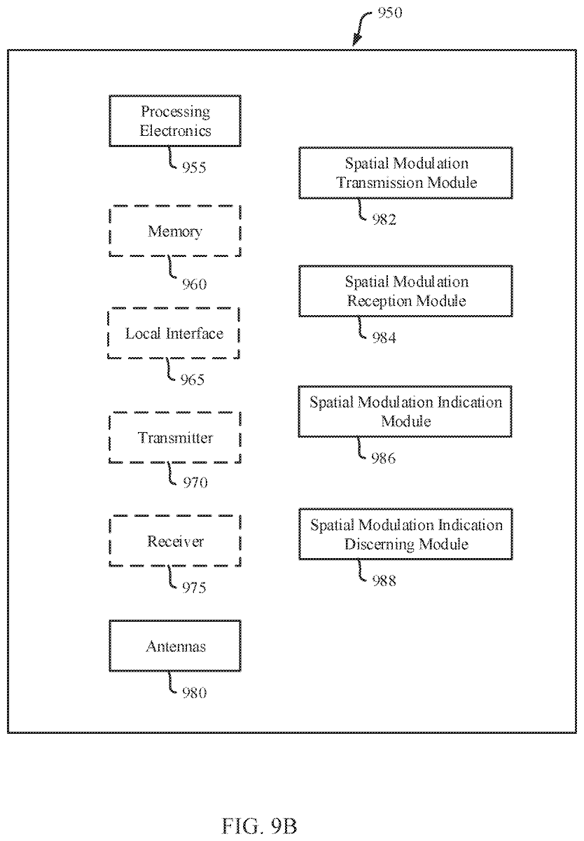

FIG. 9A illustrates an apparatus 900 that may perform any or all of operations of the above methods and features explicitly or implicitly described herein, according to different aspects of the present disclosure. For example, a computer equipped with network function may be configured as the apparatus 900. In some aspect, apparatus 900 can be a device that connects to the network infrastructure over a radio interface, such as a mobile phone, smart phone or other such device that may be classified as user equipment (UE). In some aspects, the apparatus 900 may be a Machine Type Communications (MTC) device (also referred to as a machine-to-machine (m2m) device), or another such device that may be categorized as a UE despite not providing a direct service to a user. In some aspects, apparatus 900 may be used to implement one or more aspects described herein. In some embodiments, the apparatus 900 may be a user equipment (UE), an AP, a STA, a transmitter, a receiver, another IEEE 802.11 or Wi-Fi™ device, or the like as appreciated by a person skilled in the art.

As shown, the apparatus 900 may include a processor 905, such as a Central Processing Unit (CPU) or specialized processors such as a Graphics Processing Unit (GPU) or other such processor unit, memory 910, non-transitory mass storage 915, input-output interface 920, network interface 925, and a transceiver 930, all of which are communicatively coupled via bi-directional bus 935. Transceiver 930 may include one or multiple antennas According to certain aspects, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 910 may include any type of non-transitory memory such as static random-access memory (SRAM), dynamic random-access memory (DRAM), synchronous DRAM (SDRAM), read-only memory (ROM), any combination of such, or the like. The mass storage element 915 may include any type of non-transitory storage device, such as a solid-state drive, hard disk drive, a magnetic disk drive, an optical disk drive, USB drive, or any computer program product configured to store data and machine executable program code. According to certain aspects, the memory 910 or mass storage 915 may have recorded thereon statements and instructions executable by the processor 905 for performing any method operations described herein.

The processor 905 and memory 910 may function together as a chipset which may be provided together for installation into wireless communication apparatus 900 in order to implement WLAN functionality. The chipset may be configured to receive as input data including but not limited to PPDUs from the network interface 925. The chipset may be configured to output data including but not limited to PPDUs to the network interface 925. Embodiments may be implemented using a chipset (which may or may not contain a processor and memory) or other set of electronic device components. A processor may be a specialized processor. Electronic device components may include digital circuitry, analog circuitry, or a combination thereof, configured to receive bit streams and operate on the bit streams as described herein. Different blocks of circuitry may be configured to perform different functions as described herein, and operatively coupled together. Operations may be parallelized, pipelined, etc. The operations can include operations corresponding to antenna selection for spatial modulation, bit stream parsing, conversion of bits to symbols, and the like. Transmission by antennas and related operations such as power amplification can be included in some embodiments.

FIG. 9B illustrates another apparatus 950 that may perform some or all of operations of the above methods and features explicitly or implicitly described herein, according to aspects of the present disclosure. The apparatus may utilize components of the apparatus 900. The apparatus includes processing electronics 955, which may include a computer processor, digital electronics, analog electronics, or the like, or a combination thereof. The apparatus may include a memory 960 storing computer program instructions and/or data for transmitting or receiving. The apparatus may include a local interface 965 for receiving data for transmission or providing received data. The apparatus includes one or both of a transmitter 970 and a receiver 975. The apparatus includes antennas 980 for use by the transmitter and/or the receiver. The transmitter (and possibly processing electronics) may be configured at least in part according to FIG. 4 or 5. The receiver (and possibly processing electronics) may be configured at least in part according to FIG. 6.

The above components of the apparatus 950 can be configured as needed to provide for one or more functional modules, for example as follows. A spatial modulation transmission module 982 receives a bit stream, generates spatial antenna streams for transmission based on the bit stream, and also generates control signals for operating antennas to transmit wireless signals according to spatial modulation, based on the bit stream. This operation can proceed for example as described with respect to FIG. 4 or 5. A spatial modulation reception module 984 receives wireless signals (e.g. from a similar apparatus 950) and generates a received bit stream by estimating first received bits and estimating second information-carrying bits based on an estimated pattern of antenna usage corresponding to a spatial modulation. The estimated first and second bits are combined to produce a received bit stream. This operation can proceed for example as described with respect to FIG. 6.

For transmission, a spatial modulation indication module 986 provides an indication that a frame is being transmitted using spatial modulation e.g. as described herein. The indication may be made by appropriately setting a bit or subfield within a SIG field of a PHY header of the IEEE 802.11 frame being transmitted. The spatial modulation indication module 986 may further provide an indication of a number of spatial antenna streams of the SM transmission. This indication may be included in a SIG field such as a U-SIG or UHR-SIG field. For reception, a spatial modulation indication discerning module 988, in receipt of a frame, determines an indication that the frame was transmitted using spatial modulation e.g. as described herein. The indication may be determined by reading a bit or subfield within a SIG field of a PHY header of the IEEE 802.11 frame as received. The spatial modulation indication discerning module 988 may further determine, based on contents of a SIG field, a number of spatial antenna streams of the SM transmission. Not all of the above functional modules are required in all embodiments.

FIG. 10 illustrates a method, by a device of an IEEE 802.11 transmitter, according to an aspect. The method 1000 may include generating 1001 a plurality of spatial antenna streams (430 or 530) of modulation symbols based on a dynamic mapping of a plurality of spatial streams (432 or 532) to the plurality of spatial antenna streams. The dynamic mapping may be based on a stream (422 or 522) of information bits, in accordance with a spatial modulation. The method 1000 may further include causing 1002 driving of a plurality of antennas based on the plurality of spatial antenna streams to transmit an IEEE 802.11 frame. The plurality of antennas may be greater in number than or equal in number to the plurality of spatial antenna streams.

The plurality of antennas may be greater in number than the plurality of spatial antenna streams. Driving the plurality of antennas based on the plurality of spatial antenna streams may include applying the spatial antenna streams to drive the plurality of antennas in accordance with a linear mapping representable by an Antennas Mapping matrix. The plurality of spatial antenna streams 430 or 530 may be an intermediate stage which are subsequently mapped to and used to drive the plurality of antennas.

The method may further include applying a respective cyclic shift delay (via CSD function block 412) to each of a subset of the plurality of spatial streams 432 prior to (referring to FIG. 4) the dynamic mapping of the plurality of spatial streams. The method may further include applying a respective cyclic shift delay (via CSD function block 512) to each of a subset of the plurality of spatial antenna streams 530 provided as outputs of the dynamic mapping.

FIG. 11 illustrates a method, by a device of an IEEE 802.11 transmitter, according to an aspect. The method 1100 may include causing 1101 transmission of an IEEE 802.11 frame (e.g., frame 300) using spatial modulation. The IEEE 802.11 frame may include an indication that the IEEE 802.11 frame is transmitted using the spatial modulation, the indication being a subfield within a SIG field of a PHY header of the IEEE 802.11 frame.

The SIG field may be a U-SIG field 310 or a UHR-SIG field 312. The subfield may have a length of one bit. Transmitting the IEEE 802.11 frame using spatial modulation may include generating a number of spatial antenna streams (e.g., 430 or 530), of the spatial modulation, which are used to drive a plurality of antennas greater in number or equal in number to the number of spatial antenna streams, the number of spatial antenna streams being indicated in a U-SIG field 310 or a UHR-SIG field 312 of the IEEE 802.11 frame.

FIG. 12 illustrates a method, by a device of an IEEE 802.11 transmitter, according to an aspect. The method 1200 includes parsing 1201 a non-channel-encoded bit stream (425 in FIGS. 4 and 525 in FIG. 5) into a first stream (422 in FIGS. 4 and 522 in FIG. 5) and a second stream (424 in FIGS. 4 and 524 in FIG. 5). The method 1200 may further include generating 1202 a plurality of spatial streams 432 and 532 of modulation symbols based on the second stream (424 in FIGS. 4 and 524 in FIG. 5). The method 1200 may further include dynamically mapping 1203 the plurality of spatial streams 432 and 532 of modulation symbols to a plurality of spatial antenna streams 430 and 530 respectively based on the first stream 422 and 522 respectively, without channel encoding the first stream, thereby providing for spatial modulation of the bit stream. The method 1200 may further include causing driving of a plurality of antennas based on the plurality of spatial antenna streams to transmit an IEEE 802.11 frame e.g., frame 300, the plurality of antennas being greater in number than or equal in number to the plurality of spatial antenna streams. The non-channel-encoded bit stream may be a scrambled bit stream.

The method 1200 may further include channel encoding the second stream (424 in FIGS. 4 and 524 in FIG. 5) to provide an encoded second stream (426 in FIGS. 4 and 526 in FIG. 5). Generating the plurality of spatial streams of modulation symbols (432 in FIGS. 4 and 532 in FIG. 5) may be based on the encoded second stream (426 in FIGS. 4 and 526 in FIG. 5).

The method 1200 may further include applying a respective cyclic shift delay (412 in FIG. 4) to each of a subset of the plurality of spatial streams 432 prior to said dynamically mapping of the plurality of spatial streams. The method may further include applying a respective cyclic shift delay (512 in FIG. 5) to each of a subset of the plurality of spatial antenna streams 530.

Driving the plurality of antennas based on the plurality of spatial antenna streams may include applying the spatial antenna streams to drive the plurality of antennas in accordance with a linear mapping representable by an Antennas Mapping matrix.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, by a device of an IEEE 802.11 transmitter:
causing transmission of an IEEE 802.11 frame using spatial modulation,
wherein the IEEE 802.11 frame includes an indication that the IEEE 802.11 frame is transmitted using the spatial modulation, the indication being a subfield within a SIG field of a PHY header of the IEEE 802.11 frame.

2. The method of claim 1, wherein the SIG field is a U-SIG field or a UHR-SIG field.

3. The method of claim 1, wherein the subfield has a length of one bit.

4. The method of claim 1, wherein transmitting the IEEE 802.11 frame using spatial modulation comprises generating a number of spatial antenna streams, of the spatial modulation, which are used to drive a plurality of antennas greater in number or equal in number to the number of spatial antenna streams, the number of spatial antenna streams being indicated in a U-SIG field or a UHR-SIG field of the IEEE 802.11 frame.

5. A method comprising, by a device of an IEEE 802.11 transmitter:
parsing a non-channel-encoded bit stream into a first stream and a second stream;
generating a plurality of spatial streams of modulation symbols based on the second stream;
dynamically mapping the plurality of spatial streams of modulation symbols to a plurality of spatial antenna streams based on the first stream, without channel encoding the first stream, thereby providing for spatial modulation of the bit stream; and
causing driving of a plurality of antennas based on the plurality of spatial antenna streams to transmit an IEEE 802.11 frame, the plurality of antennas being greater in number than or equal in number to the plurality of spatial antenna streams.

6. The method of claim 5, further comprising channel encoding the second stream to provide an encoded second stream, and generating the plurality of spatial streams of modulation symbols based on the encoded second stream.

7. The method of claim 5, further comprising:
applying a respective cyclic shift delay to each of a subset of the plurality of spatial streams prior to said dynamically mapping of the plurality of spatial streams.

8. The method of claim 5, further comprising:
applying a respective cyclic shift delay to each of a subset of the plurality of spatial antenna streams.

9. The method of claim 5, wherein the non-channel-encoded bit stream is a scrambled bit stream.

10. The method of claim 5, wherein the plurality of antennas is greater in number than the plurality of spatial antenna streams.

11. The method of claim 10, wherein driving the plurality of antennas based on the plurality of spatial antenna streams comprises applying the spatial antenna streams to drive the plurality of antennas in accordance with a linear mapping representable by an Antennas Mapping matrix.

12. The method of claim 5, wherein driving the plurality of antennas based on the plurality of spatial antenna streams comprises applying the spatial antenna streams to drive the plurality of antennas in accordance with a linear mapping representable by an Antennas Mapping matrix, and wherein the Antennas Mapping matrix is other than an identity matrix.

13. The method of claim 5, wherein the plurality of spatial antenna streams are an intermediate stage which are subsequently mapped to and used to drive the plurality of antennas.

14. An IEEE 802.11 transmitter apparatus configured to:
cause transmission of an IEEE 802.11 frame using spatial modulation,
wherein the IEEE 802.11 frame includes an indication that the IEEE 802.11 frame is transmitted using the spatial modulation, the indication being a subfield within a SIG field of a PHY header of the IEEE 802.11 frame.

15. The apparatus of claim 14, wherein the SIG field is a U-SIG field or a UHR-SIG field.

16. The apparatus of claim 14, wherein the subfield has a length of one bit.

17. The apparatus of claim 14, wherein transmitting the IEEE 802.11 frame using spatial modulation comprises generating a number of spatial antenna streams, of the spatial modulation, which are used to drive a plurality of antennas greater in number or equal in number to the number of spatial antenna streams, the number of spatial antenna streams being indicated in a U-SIG field or a UHR-SIG field of the IEEE 802.11 frame.

18. An apparatus, in a device of an IEEE 802.11 transmitter, the apparatus configured to:
parse a non-channel-encoded bit stream into a first stream and a second stream;
generate a plurality of spatial streams of modulation symbols based on the second stream;
dynamically map the plurality of spatial streams of modulation symbols to a plurality of spatial antenna streams based on the first stream, without channel encoding the first stream, thereby providing for spatial modulation of the bit stream; and
cause driving of a plurality of antennas based on the plurality of spatial antenna streams to transmit an IEEE 802.11 frame, the plurality of antennas being greater in number than or equal in number to the plurality of spatial antenna streams.

19. The apparatus of claim 18, further configured to channel encode the second stream to provide an encoded second stream, and to generate the plurality of spatial streams of modulation symbols based on the encoded second stream.

20. The apparatus of claim 18, further configured to:
apply a respective cyclic shift delay to each of a subset of the plurality of spatial streams prior to said dynamically mapping of the plurality of spatial streams.

21. The apparatus of claim 18, further configured to:
apply a respective cyclic shift delay to each of a subset of the plurality of spatial antenna streams.

22. The apparatus of claim 18, wherein the non-channel-encoded bit stream is a scrambled bit stream.

23. The apparatus of claim 18, wherein the plurality of antennas is greater in number than the plurality of spatial antenna streams.

24. The apparatus of claim 23, wherein driving the plurality of antennas based on the plurality of spatial antenna streams comprises applying the spatial antenna streams to drive the plurality of antennas in accordance with a linear mapping representable by a Antennas Mapping matrix.

25. The apparatus of claim 18, wherein driving the plurality of antennas based on the plurality of spatial antenna streams comprises applying the spatial antenna streams to drive the plurality of antennas in accordance with a linear mapping representable by an Antennas Mapping matrix, and wherein the Antennas Mapping matrix is other than an identity matrix.

26. The apparatus of claim 18, wherein the plurality of spatial antenna streams are an intermediate stage which are subsequently mapped to and used to drive the plurality of antennas.
